(19) United States
(12) Patent Application Publication
(10) Pub. No.: US 2026/0320563 A1
(43) Pub. Date: Oct. 15, 2026

(54) AUTOMATIC IDENTIFICATION AND ACQUISITION OF REPLACEMENT PARTS FOR A TECHNICAL SYSTEM

(71) Applicant: Siemens Mobility GmbH, München (DE)

(72) Inventor: Enrico Pasquale Marino, Erlangen (DE)

(21) Appl. No.: 19/480,894

(22) PCT Filed: Mar. 28, 2024
(86) PCT No.: PCT/EP2024/058628

§ 371 Date: Nov. 3, 2025

(30) Foreign Application Priority Data
May 2, 2023 (DE) 10 2023 204 026.3

(51) Int. Cl. G06Q 10/20; G06K 7/10; G06K 7/14

(52) U.S. Cl. CPC G06Q 10/20; G06K 7/10712; G06K 7/1413; G06K 7/1417

(57) ABSTRACT

A method automatically identifies a required replacement part for a technical system. Furthermore, a component of the technical system that is to be replaced is located, based on a previously performed fault analysis of the technical system, by a mobile electronic terminal belonging to a maintenance person. The terminal has an image recording unit for optically capturing image data. Image data of the component to be replaced are subsequently recorded by the mobile electronic terminal. Finally, the component to be replaced is identified automatically based on the image data and based on replacement part data from an electronic replacement part database, and the required replacement part is identified automatically based on the identified component to be replaced and the replacement part data.

The invention relates to a method for automated identification of a replacement part for a technical system. Additionally, the invention relates to a method for training a method for automated identification of a required replacement part for a technical system. Moreover, the invention relates to an identification system.

Complex technical systems, in particular rail vehicles, have a multiplicity of integrated subsystems and components. If individual components are worn or defective or if the architecture of the system is supposed to be changed or extended in order to change or add functionalities, then technical subsystems or technical components need to be replaced or added.

In the event of a sudden defect and failure of a technical subsystem or a single technical component, a repair should be carried out as quickly and correctly as possible in order to minimize the down time for the technical system and permit resumption of reliable operation of the system after the shortest time possible.

To achieve this aim, a replacement parts list in paper form, as a local file or as information available via a data network is created for most complex technical systems. When used, this replacement parts list needs to be searched by a specially trained maintenance person in order to quickly and correctly identify a replacement part appropriate to a specific maintenance measure.

In the case of very complex systems, in which some components differ from one another only in small details related to the architecture and the functionality of the system itself, correct identification of the relevant replacement part can be laborious and the overall efficiency of the maintenance operation can be greatly reduced. By way of example, an operation of this kind can result in a component being ordered that is very similar to the required component but that does not restore the correct function of the overall system because its functionality differs to a greater or lesser extent from the component that is actually required. Such difficulties arise for example when replacing microprocessor boards that are identical in terms of their hardware configuration but differ in terms of the installed software. Often, a microprocessor board having the latest software version is ordered as a replacement part, but this software version does not match the software version of the microprocessor board to be replaced. In such a case, following replacement, the system can malfunction if the latest software version is not compatible with the other components of the system. Installation of a replacement part that may indeed work can also result in the overall configuration of the system being changed and a license that was granted only for the original configuration lapsing. In such a case, it is necessary to apply for a new license, which can give rise to considerable costs.

Today, replacement parts catalogs are often made available to trained and experienced maintenance personnel as an electronic version in a data network. These can be searched by proficient persons more quickly than conventional paper lists. Additionally, they can be viewed simultaneously by persons using different terminals, for example by an engineer in a workshop and an engineer in the warehouse.

Furthermore, such electronic versions of replacement parts catalogs accessible via a data network can be easily updated to be able to continuously show all changing variants of different system components. Lists of this kind sometimes also allow the replacement parts required for maintenance to be ordered online, but it continues to be difficult to correctly identify the component to be replaced in the system and in the replacement parts catalog quickly and without the assistance of other technical experts.

In the case of complex systems, correct and rapid identification of this kind requires some expertise and a certain level of training, which is not always present in the personnel responsible for a repair. Particularly when time is short, such a situation can therefore lead to incorrect identification of a component and to an incorrect replacement part being ordered.

The object is thus to make a maintenance process that comprises replacing technical components of a technical system, in particular a rail vehicle, more effective using technical means.

This object is achieved by a method for automated identification of a required replacement part for a technical system according to patent claim 1, a method for training a method for automated identification of a required replacement part for a technical system according to patent claim 11, and an identification system according to patent claim 13.

The inventive method for automated identification of a required replacement part for a technical system, preferably a technical system that is used in rail transport, for example a rail vehicle or a part of a rail vehicle, first of all involves determining location information about the position and the type of a component to be replaced of the technical system on the basis of a previously performed fault analysis of the technical system. By way of example, the fault analysis can be carried out by a maintenance person, who can trace back the defective part that has caused the failure. The mobile electronic terminal preferably comprises a portable electronic terminal, particularly preferably a smartphone or a tablet or another form of portable electronic computer and/or communication system. The mobile electronic terminal comprises an image capture unit for optically acquiring image data.

Furthermore, image data are captured from the located component to be replaced by way of the mobile electronic terminal on the basis of the location information. Knowledge of the general type or the general shape and the position of the component to be replaced can be taken as a basis for an image capture by the mobile electronic terminal being performed selectively in the technical system.

Subsequently, automated identification of the component to be replaced is performed on the basis of the image data and on the basis of replacement part data of an electronic replacement parts database. Replacement part data are intended to be understood to mean the data that are typically recorded in a maintenance manual or a replacement parts catalog concerning replacement parts for a technical system. In particular, the replacement part data include information for unique and exact identification of the replacement part, image data, data about the function of the replacement part and information about the specific technical systems in which a respective replacement part can be installed and how the replacement, or installation and removal of the respective replacement part, can be effected. Other information can relate to the source of supply of the replacement part and additional information required for ordering such a replacement part.

Finally, an automated process identifies the required replacement part on the basis of the identified component to be replaced and the replacement part data. Generally, the required replacement part is of identical type to the component to be replaced. However, it can also be useful to take updated replacement part data of the replacement parts database as a basis for installing a successor replacement part having improved technical properties in the technical system instead of the old component.

Advantageously, the inventive method for identifying replacement parts to be ordered does not require maintenance persons specially trained for this purpose, as the maintenance person generally simply needs to follow the information and suggestions determined by an automated process.

The inventive method additionally affords the advantage that replacement parts can also be identified by persons with a purely general level of technical training, i.e. a person without detailed knowledge of the system architecture of the relevant technical system, without detailed knowledge of the structure of the associated replacement parts catalog and without particular experience with similar searching within the system to be maintained. The inventive method also affords the advantage that no specific hardware is necessary. Instead, a maintenance person is provided with an application program that is configured to carry out the inventive identification method on a mobile terminal of the maintenance person that the maintenance person uses for their maintenance work. The application program is configured to take image data captured using the image capture unit of the mobile terminal as a basis for recognizing a component to be replaced of a technical system and quickly leading the user to identify the replacement part to be ordered and finally ordering said replacement part from the manufacturer or another original replacement parts dealer.

The risk of an order error is also reduced, as the replacement part is selected by an automated process and slips or errors in the selection and ordering of a replacement part due to a lack of competence are prevented.

The inventive method for training a method for automated identification of a required replacement part for a technical system, in particular for training the step of the aforementioned method for automated identification of the component to be replaced on the basis of the image data and on the basis of replacement part data of an electronic replacement parts database, first of all involves generating labeled training data, which include replacement part data of a replacement parts database for technical components of a technical system, image data relating to the technical components of the technical system, acquired by a mobile terminal, and correct identification data for technical components concerning the acquired image data. Such training is particularly effective when the inventive method for automated identification of a required replacement part for a technical system is implemented on an AI basis (AI is an acronym for “Artificial Intelligence”). That is to say that automated identification is performed on the basis of an AI-based model. The described training method is a form of so-called machine learning in which the AI-based model is tailored to the labeled training data. The tailoring is preferably performed by iteratively optimizing a target function and by using a so-called backpropagation algorithm, which is used to tailor nodes and weightings of an artificial neural network to the labeled training data. Preferably, the training data include particularly detailed three-dimensional data relating to the components, which have preferably been generated by CAD programs during the development of the components and/or the system with which the components are associated. Three-dimensional data of this kind are preferably available in the STEP format. Such data are made available by many manufacturers of technical components right in the early design phases of a technical system. STEP is a standard for describing product data that includes physical and functional aspects. Based on the standardization, STEP is well suited to the data interchange between different systems in the product development process.

Training is a gradual process. In a first step, the CAD-based data (CAD is an abbreviation for “Computer Aided Design”) relating to all replaceable components (referred to as “line replaceable units”, abbreviated to “LRU”) are stored in a replacement parts database. In a second step, each LRU is preferably linked to multiple easy-to-handle and preferably compressed image data files, preferably “jpg” images. These image data files are generated by image captures from the components and provide additional information for automated identification of the components to be replaced. The image data files preferably also include images of the component that are shown in an electrical, pneumatic or mechanical diagram (e.g. in the “dwg” format).

It may even be the case that the user is not even able to physically reach the faulty part and prefers to create a representation on the circuit diagrams for the maintenance personnel instead of the physical part. This is because these diagrams include some information that can help to identify the part, even if it is not physically visible.

The training can thus be carried out before a technical system is actually commissioned, and so the inventive method for automated identification of a required replacement part for a technical system is available in particularly high quality right at the start of use of the technical system by a user. Additionally, the training can also be carried out during operation of the technical system, and the precision of the method can be improved.

Furthermore, automated identification of a replacement part is performed on the basis of the acquired image data by the inventive method for automated identification of a required replacement part for a technical system, which method is implemented by an AI-based model.

Finally, a tailoring step for the AI-based model on which the automated method is based is performed on the basis of the identification data determined by an automated process and the correct identification data relating to the technical components and the associated replacement parts of the labeled training data. Advantageously, the inventive method for automated identification of a required replacement part for a technical system is flexibly tailored to a specific application, in particular if the training data include technical components from the later area of application. Extensive use of such forms of artificial intelligence can afford the additional advantage that if machine learning algorithms are used, the effectiveness thereof and the accuracy of the results thereof increase over the course of the period of application. In particular, machine learning algorithms can continue to be trained during their use by virtue of image data and replacement part data and also identification data that are used for maintenance being able to be incorporated into the training.

The inventive identification system comprises a locating unit for locating a component to be replaced of a technical system on the basis of a previously performed fault analysis of the technical system. The locating unit provides a maintenance person with information about the position of the component to be replaced in the technical system. By way of example, the technical system is graphically displayed to the maintenance person and the component to be replaced is marked in the graphical representation, so that the maintenance person is provided with information about the position in the technical system at which the component to be replaced is located.

The inventive identification system also comprises an image capture unit for capturing image data from the located component to be replaced.

The inventive identification system also includes an electronic replacement parts database that includes replacement part data about replaceable components of a technical system. In contrast to conventional AI-based search systems that are used to search the entire Internet for images and that return a large number of similar objects as results, the scope of the search for the replacement part in the present invention is restricted to the region of the system to be maintained. This is because the search is carried out not on the entire Internet, but rather only in a quite specific database, preferably the replacement parts database.

The inventive identification system also comprises an identification unit for automated identification of the component to be replaced on the basis of the image data and on the basis of replacement part data of the electronic replacement parts database and for automatically identifying the required replacement part on the basis of the identified component to be replaced and the replacement part data. The inventive identification system shares the advantages of the inventive method for automated identification of a required replacement part for a technical system.

Some of the aforementioned components of the inventive identification system, in particular the locating unit, the electronic replacement parts database and the identification unit, can be implemented wholly or in part in the form of software modules in a processor of an applicable computing system, e.g. of a mobile electronic terminal or another computing system available to a maintenance person. A largely software-based implementation has the advantage that mobile electronic terminals and computing systems already used in the maintenance of technical systems hitherto can easily be upgraded by way of a software update in order to operate in the inventive manner.

In this respect, the object is also achieved by a corresponding computer program product comprising a computer program that can be loaded directly into a computing system, preferably of a mobile electronic terminal, having program sections to carry out the steps of the inventive method for automated identification of a required replacement part for a technical system for locating a component to be replaced, for image capture of the component to be replaced and for identifying the component to be replaced and for identifying the replacement part to be installed instead of the component to be replaced and also the steps of the inventive method for training a method for automated identification of a required replacement part for a technical system for generating training data, for performing automated identification of a replacement part and for tailoring the automated method on the basis of the identification data determined by an automated process and the correct identification data when the program is executed in the computing system. Advantageously, such a computer program product can comprise not only the computer program but also, if necessary, additional parts, e.g. a documentation, and/or additional components, including hardware components, e.g. hardware keys (dongles, etc.) for using the software.

In particular, carrying out the inventive method also requires no specific hardware, as it suffices for a maintenance person to obtain or download a specific application program from a data network or another data source and to install the application program on their mobile electronic terminal. In particular, the application program can, after authentication of the user profile of the maintenance person and approval for access to the image capture unit of the mobile electronic terminal, use an AI based algorithm to recognize individual components of a technical system and quickly lead the maintenance person to identify a replacement part to be ordered and order said replacement part from the manufacturer or another original replacement part dealer using an automated or semi-automated process. It is particularly advantageous if the application program can be easily downloaded from a data network or another accessible data source as a result of input of a specific identification code relating to a technical system, preferably an alphanumeric code or a QR code or a barcode mounted on the relevant technical system and likewise shown in a documentation relating to the technical system or displayed in another manner in regions accessible for maintenance of the technical system. Advantageously, searching for the correct application program for identifying a replacement part for a specific technical system is made easy for the maintenance person.

Transport to the computing system and/or storage on or in the computing system can be achieved using a computer-readable medium, e.g. a memory stick, a hard disk or another transportable or permanently installed data carrier storing the program sections of the computer program that are able to be read in and executed by a computing system.

To this end, the computing system can comprise e.g. one or more cooperating microprocessors or the like. The dependent claims and the description that follows each contain particularly advantageous configurations and developments of the invention. In particular, the claims in one claim category may also have been developed analogously to the dependent claims in another claim category and the parts of the description relating thereto. Moreover, the invention also allows the various features of different exemplary embodiments and claims to be combined to produce new exemplary embodiments.

Preferably, in the inventive method for automated identification of a required replacement part for a technical system, the step of automated identification of the component to be replaced involves the following Substeps being performed: it is determined whether the component to be replaced is uniquely identifiable. This is determined on the basis of a comparison of the image data with the replacement part data of the electronic replacement parts database. The acquired image data are assigned replacement parts and the identification data relating thereto in the electronic replacement parts database. If only one replacement part can be uniquely assigned to the acquired image data, the identification is rated as unique. If multiple different replacement parts with different identification data are assigned to the acquired image data, the identification is classified as not unique. For components for which multiple versions exist, additional recognition steps need to be performed, visual recognition of a component being followed by recognition of the respective version.

In such a case in which the component to be replaced is not uniquely identifiable, a specific prompt to a maintenance person for appropriate interaction with the mobile electronic terminal on the basis of the image data and the replacement part data of the electronic replacement parts database is determined, or transmitted to this maintenance person. The maintenance person is thus prompted to take a measure to permit unique identification of the component to be replaced. In this operation, the determined “candidates” and information associated with these candidates from the replacement parts database can make unique identification easy for the maintenance person.

The specific prompt to uniquely identify the component to be replaced preferably comprises a prompt to perform one of the following specific interactions: an automated prompt to mark and/or segment identification codes relating to the component to be replaced that are shown in the image data is preferably transmitted, preferably displayed, to the maintenance person. Such an operation can comprise for example distinguishing codes, in particular alphanumeric codes, barcodes, QR codes that have been mounted, for example using self-adhesive tags or metal plates, on the component during production or during installation, or the like as identification codes in the image data that are displayed on the display unit of the mobile electronic terminal. The maintenance person can thus distinguish a region in the image data that is relevant to identifying a component to be replaced. A very small region of a diagram (e.g. circuit diagram) in which the component is visually recognizable can be distinguished. This would be an advantage for components that cannot be reached (distinguished) as easily and directly by way of an image capture by the mobile terminal. The maintenance person is thus guided in selecting the correct version of the replacement part using the most suitable method.

Furthermore, if the maintenance person has not carried out marking and/or segmentation, an automated prompt to input an identification code relating to the component to be replaced, for example a reference code, in particular a serial number or a commissioning date, is preferably transmitted, or displayed, to the maintenance person. If the component to be replaced is an electric or pneumatic component, an automated prompt to input a component name on the basis of a preferably displayed electrical or pneumatic circuit diagram of the technical system is preferably transmitted, preferably displayed, to the maintenance person. Advantageously, the maintenance person is provided, if necessary on the basis of additional stored information, with the option of undertaking the identification themselves; in that case, the identification is preferably carried out on the basis of the prior determination already carried out, so that the identification is made easy for the maintenance person.

For safety, automated identification of the component to be replaced on the basis of the image data preferably comprises presenting provisional identification data relating to the identified component to be replaced on the mobile terminal of the maintenance person, and a prompt for the maintenance person to input confirmation of correct identification of the component to be replaced. Advantageously, the result of the automated identification also needs to be confirmed by a human being. The involvement of a second instance greatly reduces the probability of incorrect identification.

If unique or correct automated identification of the component to be replaced has not occurred, an automated process preferably prompts the maintenance person to take the replacement part data of the electronic replacement parts database as a basis for manually performing the identification by identifying and selecting the component to be replaced in the electronic replacement parts database, and to this end the replacement part data of the electronic replacement parts database are displayed to the maintenance person. The maintenance person can thus alternatively also choose a conventional approach when identifying the replacement part if automated identification has not led to a correct or unique result.

Additionally, if, as here, unique or correct automated identification has not occurred, an automated process preferably transmits to the maintenance person a prompt message asking them to use the mobile terminal to acquire detailed image data from different perspectives from the component to be replaced. On the basis of the detailed image data, an automated process preferably generates enhanced replacement part data, the detailed image data and the information about the manually identified and selected component to be replaced being added to the replacement part data of the electronic replacement parts database. These enhanced and improved replacement part data are subsequently preferably used for automated training of the automated identification on the basis of the enhanced replacement part data of the electronic replacement parts database. Advantageously, the automated method for identifying a component to be replaced of a technical system is constantly improved further during use of this method, and so the precision and reliability of the method and also the breadth of the area of application to which the method can be applied can be increased to an ever greater extent.

This approach works particularly well if the component to be replaced is identified by applying an AI-based algorithm. Such an AI-based algorithm is trained by machine learning and, in contrast to a rigid or parameterizable model structure, can be tailored particularly flexibly to changing requirements.

After the component to be replaced has been identified, additional steps can be performed to guide the maintenance person through the ordering and replacement process. Advantageously, even inexperienced maintenance persons can easily master the ordering operation. Furthermore, the time required for the ordering operation is reduced, since the maintenance person does not themselves have to consider which step needs to be performed next, what information is required therefor and specifically how the step can be performed.

Preferably, at least one of the following automated additional steps for a replacement process for the identified component to be replaced is thus performed, preferably using the mobile electronic terminal: a prompt to order a suitable replacement part for the identified component to be replaced is transmitted to the maintenance person, or preferably displayed to this maintenance person, and an input from the maintenance person to order the suitable replacement part is accepted. Advantageously, the maintenance person can perform the identification and the ordering in a single shared process.

Also preferably, a prompt to input the number of replacement parts to be ordered is displayed and the input from the maintenance person regarding the number of replacement parts to be ordered is accepted. Advantageously, the correct number of already identified replacement part is determined and incorporated into the ordering operation.

Likewise preferably, recommended tools concerning the identified component to be replaced and/or recommended technical accessories concerning the identified component to be replaced are displayed and a prompt to select and order the recommended tool and/or the technical accessories is displayed and an input of the selection and order from the maintenance person is accepted. Recommended useful technical accessories preferably include mechanical mounting kits, for example screw connection material, or electric and/or pneumatic connecting elements, fixing or finishing material, seals or other additional parts that are often damaged when a component is replaced. Such accessories are preferably combined in the form of a replacement kit. Advantageously, replacement of the relevant component is made possible or easy by the availability and combined ordering of the tool and suitable accessories together with the required replacement part.

Additionally, as a preferred additional step, a prompt to input a delivery address for the ordered replacement parts and the ordered accessories is displayed and an input of a delivery address from the maintenance person is accepted.

Likewise in the form of a preferred additional step, a message containing a confirmation and summary of the order is displayed to document the completion of the ordering operation for the required replacement part.

Once the ordered replacement part has been delivered, further image data are preferably captured from the delivered replacement part and the image data and the replacement part data of the electronic replacement parts database are taken as a basis for an automated process to check whether the delivered replacement part matches the identified replacement part. Advantageously, the maintenance person is thus also assisted in checking the delivered replacement part, which makes the replacement operation more reliable and safer.

To make it easy for the maintenance person to remove the component to be replaced and install the delivered replacement part, after a replacement part has been delivered, the identification data relating to the delivered replacement part and an electronic maintenance manual are preferably taken as a basis for displaying instructions for replacing the identified component to be replaced with the delivered replacement part to the maintenance person.

To improve the method for identifying a required replacement part for a technical system further, the labeled training data are preferably generated by capturing image data from the technical components in a state in which the technical components are installed in the technical system, the technical components particularly preferably being captured from different viewing angles. Advantageously, the database for training the inventive method for identifying a required replacement part for a technical system is improved to an ever greater extent during use of the method, and so the reliability of the method is also improved to an ever greater extent.

The invention is explained in more detail once again below on the basis of exemplary embodiments with reference to the accompanying figures, in which:

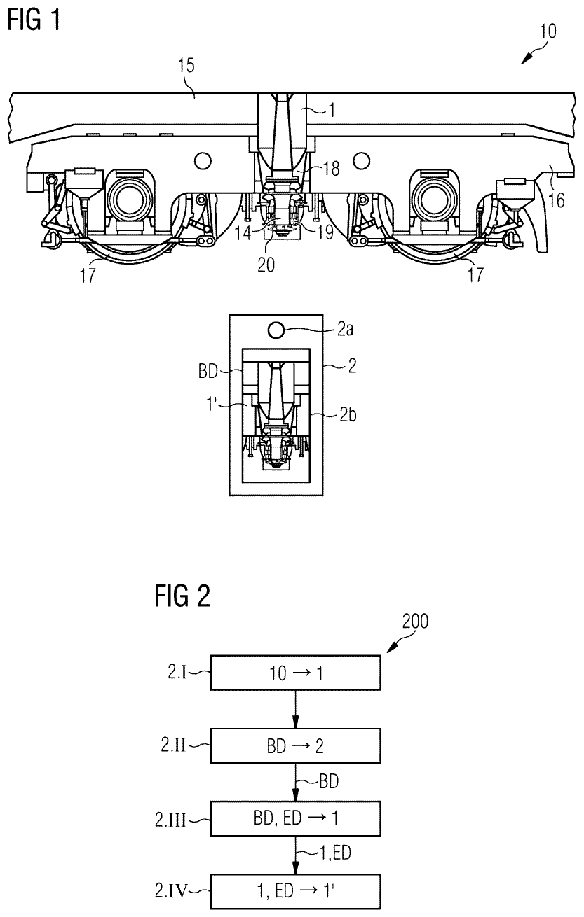

FIG. 1 shows a schematic representation of a scenario in which a component of a technical system is supposed to be replaced,

FIG. 2 shows a flowchart illustrating a method for automated identification of a required replacement part for a technical system according to an exemplary embodiment of the invention,

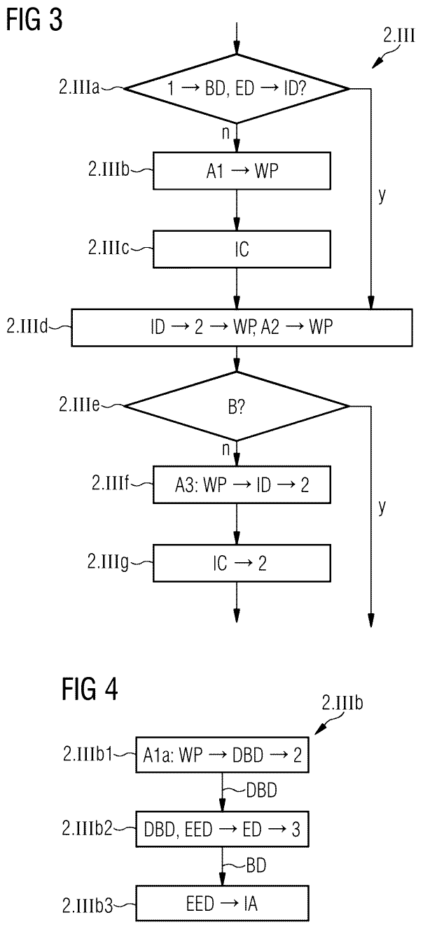

FIG. 3 shows a flowchart illustrating step 2.III of the method for automated identification of a required replacement part for a technical system, illustrated in FIG. 2, in detail,

FIG. 4 shows a flowchart showing step 2.IIIb illustrated in FIG. 3 in detail,

FIG. 5 shows a flowchart illustrating additional steps of the method, shown in FIG. 2 to FIG. 4, for automated identification of a required replacement part for a technical system, which can follow steps 2. I to 2. IV shown in FIGS. 2,

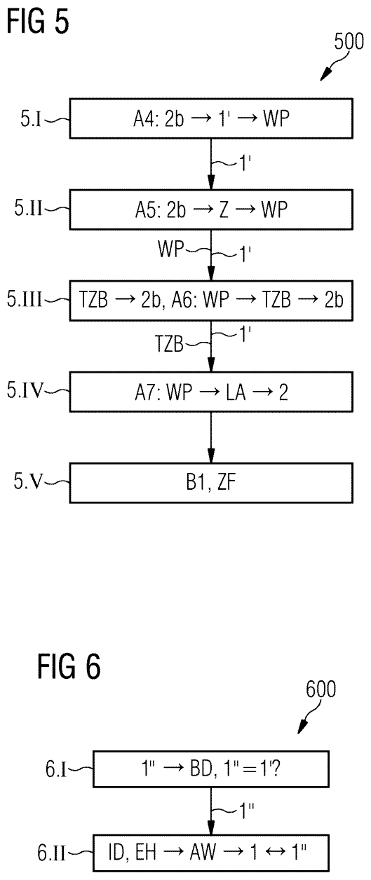

FIG. 6 shows a flowchart illustrating further steps of the method, shown in FIG. 2 to FIG. 5, for automated identification of a required replacement part for a technical system,

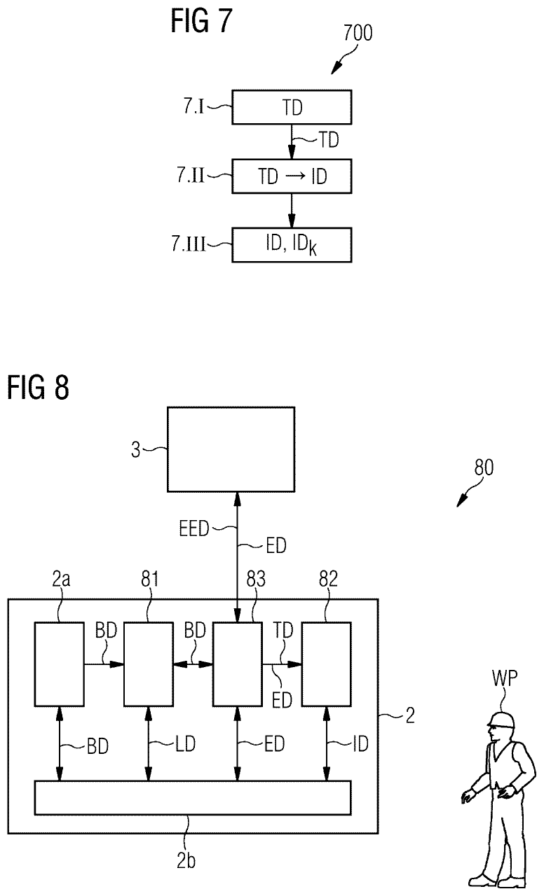

FIG. 7 shows a flowchart illustrating a method for training a method for automated identification of a required replacement part for a technical system,

FIG. 8 shows a schematic representation of an identification system according to an exemplary embodiment of the invention.

FIG. 1 shows a schematic representation of a technical system 10, in this specific case a chassis comprising a running gear 16 or bogie having wheels 17, which is mounted on a carriage body 15 by way of a bogie pin 1, or which interlocks with the bogie pin 1 of the carriage body 15. The running gear 16 has, centrally, a receiving region 18 that comprises a plurality of rubber spring elements 19 at its lower end. The carriage body 15, which is shown in the upper subsection of the graphical representation in FIG. 1, has, centrally, the aforementioned bogie pin 1. This bogie pin 1 engages in the receiving region 18 of the running gear 16. The bogie pin 1 has a tapered pin end 14 that is arranged between the rubber spring elements 19. A lifting lock 20 is provided by the head region of the pin end 14.

The mobile terminal 2 shown in FIG. 1, in this exemplary embodiment a smartphone, has an application program that is configured to carry out the method for automated identification of a required replacement part for a technical system, illustrated with regard to FIGS. 2 to 4. This method is first of all used to locate a component 1 to be replaced, in this case the bogie pin 1. By way of example, the method first of all uses a maintenance database to determine whether a component and which component of the depicted chassis needs to be replaced. Once the application program receives the information that the bogie pin 1 needs to be replaced, the mobile electronic terminal 2, in this example a smartphone, is next used to capture image data BD from the bogie pin 1 shown in FIG. 1. To this end, the mobile electronic terminal 2 comprises an image capture unit 2a, in particular a camera. Subsequently, the component 1 to be replaced, in this case a bogie pin 1, and the applicable replacement part 1′, which is generally of identical type to the component 1 to be replaced, are identified on the basis of the generated image data BD and on the basis of additional information, or replacement part data ED, which are obtained from a replacement parts database 3. These replacement part data ED include specific information about the available replacement parts, in particular about the bogie pins available as replacement part 1′. This specific information can include in particular image data, type designations, the type designations of the technical systems 10 in which the individual replacement parts 1′ can be installed, etc. Finally, the identified replacement part 1′ is displayed to the maintenance person on a display unit 2b of the mobile electronic terminal 2. A maintenance person thus no longer needs to be concerned with identifying the components 1 to be replaced and selecting a suitable replacement part 1′ in the replacement parts catalog. They merely need to confirm the suggestion for a replacement part 1′, generated by an automated process, on their mobile terminal, or smartphone, and the suitable replacement part 1′ is instantly ordered.

FIG. 2 shows a flowchart 200 illustrating a method for automated identification of a required replacement part 1′ for a technical system 10.

In step 2.I, a component 1 to be replaced of the technical system 10 is first of all located on the basis of a previously performed fault analysis of the technical system 10. By way of example, the fault analysis of the technical system 10 takes a specific defect that has arisen as a basis for delivering the result that a quite specific technical component 1 of the technical system 10 is the cause of this defect in the technical system 10, the exact type or identification data ID of said component not being known directly.

In step 2.II, image data BD are therefore captured from the located component 1 to be replaced by way of the mobile electronic terminal 2 in order to obtain information to exactly identify the component 1 to be replaced.

In step 2.III, automated identification of the component 1 to be replaced is then performed on the basis of the image data BD and on the basis of replacement part data ED of an electronic replacement parts database 3. The replacement parts database 3 includes the following replacement part data: in this regard, to provide a clear explanation, it is an electronic replacement parts catalog that lists, graphically represents and gives a detailed explanation of all replacement parts 1′ for the technical system 10. Furthermore, the replacement parts database 3 also shows identification data ID relating to the replacement parts 1′, for example a specific identification code IC. Once a replacement part 1′ exactly matching the component 1 to be replaced that is shown in the image data BD is found, this component 1 to be replaced is identified as this specific replacement part 1′.

Finally, in step 2.IV, automated identification of the required replacement part 1′ is performed on the basis of the identified component 1 to be replaced and the replacement part data ED. Generally, the required replacement part 1′ and the identified component 1 to be replaced are of identical type. However, it may also be that the replacement parts database 3 lists a more recent, more appropriate replacement part 1′ that has more favorable technical properties compared to the identified component 1 and can be swapped with the identified component 1. In such a case, it is then recommended that this particularly suitable replacement part 1′ be ordered. FIG. 3 shows a flowchart illustrating step 2.III of the method, illustrated in FIG. 2, for automated identification of a required replacement part 1′ for a technical system 10 in detail.

Substep 2.IIIa first of all determines whether the component 1 to be replaced is uniquely identifiable. This is determined on the basis of a comparison of the image data BD acquired using the mobile electronic terminal 2 with replacement part data ED of the electronic replacement parts database 3. By way of example, the image data BD contain structural features that can be used to uniquely identify the component 1 to be replaced. The electronic replacement parts database 3 also stores, for the individual type designations, images that can be compared with the acquired image data BD in order to identify the component 1 to be replaced. Identification codes IC present in the image data BD, or, in more general terms, identification data ID present in the image data BD, can also be segmented and recognized by an automated process or with the assistance of a user of the mobile electronic terminal 2. In such a case, these identification data ID now merely need to be compared with the identification data ID present in the electronic replacement parts database 3 in order to exactly identify a component 1 to be replaced.

If the component 1 to be replaced is not uniquely identifiable, which is indicated by “n” in FIG. 3, substep 2.IIIb involves a specific prompt A1 being transmitted to a maintenance person WP, i.e. such a prompt A1 is displayed to the maintenance person WP on the display unit 2b of the mobile electronic terminal 2, appropriate interaction with the mobile electronic terminal 2 on the basis of the image data BD and the replacement part data ED of the electronic replacement parts database being prompted in order to obtain unique identification data ID for the component 1 to be replaced.

In step 2.IIIc, an identification code IC is input into the mobile electronic terminal 2 by the maintenance person WP. In step 2.IIId, provisional identification data ID relating to the identified component 1 to be replaced are then presented on the display unit 2b of the mobile terminal 2 of the maintenance person WP. The identification data ID can include not only the identification code IC input by the maintenance person WP but also other information, for example a descriptive name for the component 1 to be replaced and image data BD depicting the component 1 to be replaced. Furthermore, step 2.IIId involves a prompt A2 for the maintenance person WP to input confirmation of correct identification of the component 1 to be replaced being given. The prompt A2 is displayed to the maintenance person WP on the display unit 2b of the mobile terminal 2 of the maintenance person WP.

In step 2.IIIe, a check is performed to ascertain whether the maintenance person WP has provided confirmation B that the automated identification is correct, i.e. in particular whether a corresponding input into the mobile electronic terminal 2 has been provided.

If confirmation B that unique and correct automated identification of the component 1 to be replaced has taken place has not been input, which is indicated by “n” in FIG. 3, the procedure moves to step 2.IIIf, in which the maintenance person WP is prompted by an automated process, using a third prompt message A3, to take the replacement part data ED of the electronic replacement parts database 3 as a basis for undertaking identification themselves by manually identifying and selecting the component 1 to be replaced in the electronic replacement parts database 3, and in which the replacement part data ED of the electronic replacement parts database 3 are displayed to the maintenance person WP on the display unit 2b for this purpose. The replacement part data 3 can include in particular image data, written information and particularly also identification data ID relating to the replacement parts 1′.

In step 2.IIIg, the maintenance person WP, once they have found and selected the component 1 to be replaced in the replacement parts database 3, inputs an identification code IC that can be found there for the component 1 to be replaced into their mobile electronic terminal 2 so as to complete the identification process.

FIG. 4 shows a schematic representation of step 2.IIIb illustrated in FIG. 3 in detail. In a first substep 2.IIIb1 of step 2.IIIb, an automated process transmits to the maintenance person WP a prompt message Ala asking them to use the mobile terminal 2 to acquire detailed image data DBD from different perspectives from the component 1 to be replaced.

In substep 2.IIIb2, an automated process generates enhanced replacement part data EED, the detailed image data DBD being linked to the replacement part data ED relating to the manually identified and selected component 1 to be replaced in the electronic replacement parts database 3.

In substep 2.IIIb3, automated training of the automated identification is carried out on the basis of the enhanced replacement part data EED of the electronic replacement parts database 3. Since the enhanced replacement part data EED include additional image information that is used to train the automated identification algorithm IA, which is based on an artificial neural network, there is the increased probability, after the training, that the component to be replaced, which has not been automatically identifiable hitherto, will be automatically identifiable when the opportunity next arises.

FIG. 5 shows a flowchart 500 illustrating additional steps of the method, shown in FIG. 2 to FIG. 4, for automated identification of a required replacement part 1′ for a technical system 10, which can follow steps 2.I to 2.IV shown in FIG. 2.

In step 5.I, a prompt A4 to order a suitable replacement part 1′ for the identified component 1 to be replaced is displayed to the maintenance person WP on the display unit 2b of the mobile electronic terminal 2 by an automated process.

In step 5.II, after an input to order the suitable replacement part 1′ has been accepted, a prompt A5 to input the number Z of replacement parts 1′ to be ordered is displayed on the display unit 2b of the mobile electronic terminal 2, and the input from the maintenance person WP to order the suitable replacement part 1′ is accepted.

In step 5.III, technical accessories TZB concerning the identified component 1 to be replaced are displayed to the maintenance person WP and a prompt A6 to select and order the technical accessories TZB is displayed.

In step 5.IV, a prompt A7 to input a delivery address LA for the ordered replacement parts 1′ and the ordered accessories TZB is displayed on the mobile electronic terminal 2.

In step 5.V, a message comprising a confirmation B1 and a Summary ZF of the order is displayed to the maintenance person WP on the display unit 2b of the mobile electronic terminal 2.

FIG. 6 shows a flowchart 600 illustrating further steps of the method, shown in FIG. 2 to FIG. 5, for automated identification of a required replacement part 1′ for a technical system 10, which can follow the steps and substeps illustrated in FIG. 2 to FIG. 5.

In step 6.I, after a replacement part 1″ has been delivered, image data BD are captured from the delivered replacement part 1″ and the image data BD and the replacement part data ED of the electronic replacement parts database 3 are taken as a basis for checking whether the delivered replacement part 1″ matches the replacement part 1′ identified prior to the order.

In step 6.II, if step 6.I has determined that the correct replacement part has been delivered, then, after the replacement part 1″ has been delivered, the identification data ID relating to the delivered replacement part 1″ and an electronic maintenance manual EH are taken as a basis for displaying instructions AW for replacing the identified component 1 to be replaced with the delivered replacement part 1″ to the maintenance person WP.

FIG. 7 shows a flowchart 700 illustrating a method for training a method for automated identification of a required replacement part 1′ for a technical system 10.

In step 7.I, labeled training data TD are first of all generated. The labeled training data TD already include the result data to be determined by the automated method for automated identification of a required replacement part 1′for a technical system 10 and are therefore suitable for a supervised training method in which variances in the result data of the automated method from the actual result data can be used to tailor the model on which the automated identification method is based, in particular an artificial neural network.

To generate the labeled training data TD, replacement part data ED of a replacement parts database 3 for technical components 1 of a technical system 10 are determined. Furthermore, a mobile terminal 2 acquires image data BD relating to the technical components 1 of the technical system 10 and links said image data to the replacement part data ED. Moreover, correct identification data ID relating to the technical components 1 are linked to the acquired image data BD. To generate the labeled training data TD, the image data BD are captured from the technical components 1 in the state in which they are installed in the technical system 10 and are also captured from different viewing angles.

In step 7.II, automated identification of a replacement part 1′ is performed on the basis of the acquired image data BD and the rest of the replacement part data ED. By way of example, image data BD comprising identification data ID are used as labeled training data TD as input data for the training method and identification is performed on the basis of the image data BD and the replacement part data ED, the replacement part data ED being able, for example, to deliver additional information about the properties of the components shown in the image data BD and also linking these properties to identification data.

In step 7.III, the automated method is tailored on the basis of the identification data ID determined by an automated process and the correct identification data IDk of the labeled training data TD. Such a process is also referred to as supervised training.

Steps 7.II and 7.III are repeated until a quality criterion is met for the result data or identification data ID of the method for automated identification of a required replacement part 1′ for a technical system 10.

FIG. 8 illustrates an identification system 80 according to an exemplary embodiment of the invention. The identification system 80 shown in FIG. 8 comprises a replacement parts database 3 storing replacement part data ED concerning a plurality of replacement parts 1′ for technical systems 10.

The identification system 80 additionally includes a mobile electronic terminal 2, for example a smartphone, that comprises an image capture unit 2a for capturing image data BD relating to a component 1 to be replaced (not shown in FIG. 8). The mobile electronic terminal 2 also includes a locating unit 81 for locating a component 1 to be replaced of a technical system 10 on the basis of a previously performed fault analysis of the technical system 10. By way of example, a maintenance person WP inputs information about a specific defect in the technical system 10 into the mobile electronic terminal 2 and the locating unit 81 takes this information as a basis for locating a region in the technical system 10 that contains the component 1 to be replaced. In the simplest case, the region is simply even located by the maintenance person WP.

The mobile electronic terminal 2 also includes an identification unit 82 that is configured for automated identification of the component 1 to be replaced on the basis of image data BD that have been captured from the located region by the image capture unit 2a and on the basis of replacement part data ED of the electronic replacement parts database 3 and is additionally configured to automatically identify the required replacement part 1′ on the basis of the identified component 1 to be replaced and the replacement part data ED.

The identification data ID determined by the identification unit 82 are displayed on a display unit 2b of the mobile electronic terminal 2.

The identification system 80 also includes a data generation unit 83 for generating enhanced replacement part data EED by combining newly acquired image data BD from components 1 to be replaced and delivered replacement parts 1″ with replacement part data ED already present in the replacement parts database 3 and inputs from a maintenance person WP. The data generation unit 83 is also configured to generate labeled training data TD on the basis of enhanced replacement part data EED and to transmit said labeled training data to the identification unit 82 for training. During “normal operation”, the data generation unit 83 illustrated in FIG. 8 also serves as an interface for transmitting replacement part data ED and image data BD to the identification unit 82 and for accepting inputs from a maintenance person WP via the display unit 2b.

In conclusion, it is once again pointed out that the methods and apparatuses described above are merely preferred exemplary embodiments of the invention and that the invention may be varied by a person skilled in the art without departing from the scope of the invention as predefined by the claims. For the sake of completeness, it is also pointed out that the use of the indefinite article “a” or “an” does not preclude the relevant features from also being able to be present multiple times. Likewise, the term “unit” does not preclude the latter from consisting of multiple components which, where necessary, may also be distributed in space. Irrespective of the grammatical gender of a specific term, persons of male, female or other gender identity are also included.

1-15. (canceled)

16. A method for automated identification of a required replacement part for a technical system, which comprises the steps of:
locating a component of the technical system to be replaced on a basis of a previously performed fault analysis of the technical system by way of a mobile electronic terminal of a maintenance person, the mobile electronic terminal having an image capture unit for optically acquiring image data;
capturing the image data from a located component to be replaced by way of the mobile electronic terminal;
automatically identifying the component to be replaced on a basis of the image data and on a basis of replacement part data of an electronic replacement parts database, the component to be replaced being identified by applying an AI-based algorithm;
automatically identifying a required replacement part on a basis of an identified component to be replaced and the replacement part data, the step of automatically identifying the component to be replaced comprises the substeps of:
determining whether the component to be replaced is uniquely identifiable, on a basis of a comparison of the image data with the replacement part data of the electronic replacement parts database; and
if the component to be replaced is not uniquely identifiable, determining a specific prompt to the maintenance person for appropriate interaction with the mobile electronic terminal to identify the component to be replaced on the basis of the image data and the replacement part data of the electronic replacement parts database, the specific prompt containing an automated prompt to mark and/or segment identification codes relating to the component to be replaced that are shown in the image data.

17. The method according to claim 16, wherein the specific prompt contains a prompt to perform one of the following specific interactions:
generating another automated prompt to input an identification code relating to the component to be replaced if the maintenance person has not carried out marking and/or segmentation; and
generating a further automated prompt for the maintenance person to input a component name on a basis of a displayed electrical or pneumatic circuit diagram of the technical system, if the component to be replaced is an electric or pneumatic component.

18. The method according to claim 16, wherein the step of automatically identifying the component to be replaced on the basis of the image data further comprises the sub-steps of:
presenting provisional identification data relating to the identified component to be replaced on the mobile electronic terminal of the maintenance person; and
providing a prompt for the maintenance person to input confirmation of a correct identification of the component to be replaced.

19. The method according to claim 16, wherein if unique or correct automated identification of the component to be replaced has not occurred, an automated process prompts the maintenance person to take the replacement part data of the electronic replacement parts database as a basis for manually performing the identification of the component to be replaced by identifying and selecting the component to be replaced in the electronic replacement parts database, and the replacement part data of the electronic replacement parts database are displayed to the maintenance person.

20. The method according to claim 19, wherein if unique or correct automated identification has not occurred:
an automated process transmits to the maintenance person a prompt message asking him to use the mobile electronic terminal to acquire detailed image data from different perspectives from the component to be replaced;
a further automated process generates enhanced replacement part data, the detailed image data and information about a manually identified and selected component to be replaced being added to the replacement part data of the electronic replacement parts database; and
automated training of the automated identification is carried out on a basis of the enhanced replacement part data of the electronic replacement parts database.

21. The method according to claim 16, wherein after the component to be replaced has been identified, at least one of the following automated additional steps for a replacement process for the identified component to be replaced is performed:
displaying a prompt to order a suitable replacement part for the identified component to be replaced and accepting an input from the maintenance person to order the suitable replacement part;
displaying a prompt to input a number of replacement parts to be ordered and accepting the input of the number from the maintenance person;
displaying recommended tools and/or recommended technical accessories concerning the identified component to be replaced and displaying a prompt to select and order the technical accessories and accepting an input of the selection and order from the maintenance person;
displaying a prompt to input a delivery address for ordered replacement parts and ordered accessories and accepting an input of a delivery address from the maintenance person; and
displaying a message containing a confirmation and summary of an order.

22. The method according to claim 16, wherein after a replacement part has been delivered, further image data are captured from a delivered replacement part and the further image data and the replacement part data of the electronic replacement parts database are taken as a basis for checking whether the delivered replacement part matches an identified replacement part.

23. The method according to claim 16, wherein after the required replacement part has been delivered, identification data relating to a delivered replacement part and an electronic maintenance manual are taken as a basis for displaying instructions for replacing the identified component to be replaced with the delivered replacement part to the maintenance person.

24. A method for training the step for automatically identifying the component to be replaced on the basis of the image data and on the basis of replacement part data of the electronic replacement parts database of the method for automated identification of the required replacement part for the technical system according to claim 16, which comprises the steps of:
generating labeled training data, which include:
the replacement part data of the electronic replacement parts database for technical components of the technical system;
image data relating to the technical components of the technical system, acquired by the mobile electronic terminal;
correct identification data for the technical components concerning the image data acquired;
performing automated identification of the replacement part on the basis of the image data acquired, the identification data being determined for the technical components; and
tailoring an automated method on a basis of the identification data determined by an automated process and a correct identification data relating to the technical components of the replacement parts.

25. The method according to claim 24, wherein the labeled training data are generated by capturing the image data from the technical components in a state in which the technical components are installed in the technical system and/or by capturing the image data from different viewing angles.

26. An identification system, comprising:
a locating unit for locating a component to be replaced of a technical system on a basis of a previously performed fault analysis of the technical system;
an image capture unit for capturing image data from a located component to be replaced;
an electronic replacement parts database that includes replacement part data about replaceable components of the technical system;
an identification unit for automated identification of the component to be replaced on a basis of the image data and on a basis of the replacement part data of the electronic replacement parts database and for automatically identifying a required replacement part on a basis of an identified component to be replaced and the replacement part data, the component to be replaced being identified by applying an AI-based algorithm and said identification unit configured to:
determine whether the component to be replaced is uniquely identifiable, on a basis of a comparison of the image data with the replacement part data of the electronic replacement parts database; and
determine a specific prompt to a maintenance person for appropriate interaction with the mobile electronic terminal to identify the component to be replaced on the basis of the image data and the replacement part data of the electronic replacement parts database if the component to be replaced is not uniquely identifiable, the specific prompt containing an automated prompt to mark and/or segment identification codes relating to the component to be replaced that are shown in the image data.

27. A non-transitory computer program product containing a computer program that can be loaded directly into a memory unit of a computing system, having program sections to carry out the method according to claim 16 when the computer program is executed in the computing system.

28. A non-transitory computer-readable medium storing program sections that can be executed by a computer unit to carry out the method according to claim 16.
